(19) United States
(12) Patent Application Publication
(10) Pub. No.: US 2014/0202577 A1
(43) Pub. Date: Jul. 24, 2014

(54) DUCT FITTING APPARATUS WITH REDUCED FLOW PRESSURE LOSS AND METHOD OF FORMATION THEREOF

(71) Applicant: William Gardiner WEBSTER, III, Rancho Palos Verdes, CA (US)

(72) Inventor: William Gardiner WEBSTER, III, Rancho Palos Verdes, CA (US)

(21) Appl. No.: 14/160,265

(22) Filed: Jan. 21, 2014

Related U.S. Application Data
(60) Provisional application No. 61/754,937, filed on Jan. 21, 2013.

(51) Int. Cl. F16L 9/02

(52) U.S. Cl. CPC F16L 9/02
USPC 138/177

(57) ABSTRACT

A duct fitting apparatus comprising a duct fitting having an aspect ratio of generally 1:1 at each end and transitioning toward a middle section having a non-uniform aspect ratio up to about 2.4:1. The transition section may have an elliptical cross-sectional shape. A plurality of surface treatments associated with the interior wall of the duct fitting between the upstream inlet end and the apex of divergence create aerodynamic vortices proximate to the wall of the inside bend of the curve, resulting in lower loss of total pressure of air or fluid passing therethrough.

### CROSS-REFERENCE TO RELATED APPLICATION

This application claims benefit of copending U.S. provisional patent application No. 61/754,937, filed Jan. 21, 2013, entitled “Turbulence Reducing Duct Element,” the disclosure of which is incorporated by reference in its entirety herein.

### FIELD

The present disclosure relates to duct fitting apparatus. More particularly, exemplary embodiments are provided for duct fitting apparatus for and methods of reducing pressure loss, as a result of turbulence and boundary layer separation present within a bent or diverging duct.

### BACKGROUND

As of 2011, building operations generated approximately 54% of the world's carbon dioxide emissions: 45% from occupancy loads and 55% from mechanically driven Heating, Ventilating and Air Conditioning (HVAC) devices. It is inherent that fans consume nearly 23% of the electricity in buildings and so are excellent candidates for efficiency optimization when seeking opportunities to reduce the carbon footprint and operating cost in the built environment. Recent policy, including LEED® (Leadership in Energy & Environmental Design) initiatives, has created incentives for building owners and operators to mandate increasingly efficient HVAC configurations. While many active HVAC system components, such as blowers, digital controllers and convection devices, have witnessed significant technological strides, many critical passive technologies remain largely inadequate. For the past half-century, traditional square, oval and circular ductwork components have assumed a ubiquitous presence throughout the building industry. As both the single largest intermediary between the building environment system and the occupant, these nondescript conduits also provide the single largest source of operational inefficiency. For the past half-century, traditional square, oval and circular duct systems have become ubiquitous agents throughout the building industry. Efforts to address inefficiencies in blower operation and diffuser design have resulted in a myriad of solutions each focused on the ductwork which unites them.

Akin to all viscous fluids enclosed within a pipe, conditioned air exerts shear stresses upon the walls of ducts which transport its medium. These resistance forces manifest as friction loss and dynamic head loss (the reduction in duct pressure due to bends, elbows, joints, valves, etc., or other reductions in the diameter of the duct or change in the air flow pattern) dynamic or minor head losses are a common misnomer because in many cases these losses are more important and far more extreme than the losses due to surface friction within HVAC systems. When flow (air or other fluid or liquid) enters a bent or diverging duct fitting, the faster moving laminas near the center axis get displaced outward due to inertial forces. The result is a migration of flow from the inner toward the outer radius of the curvature. This migration subjugates the primary flow to a collection of vortical regions along both the inner and outer duct walls along the bent or diverging portion. Helical in nature, these vortical regions are comprised of relatively low fluid velocities which induce restrictive conveyance patterns superimposed upon the primary direction of flow. As a result, mechanical fans must compensate for these pressure losses through decreased efficiency and increased operating costs.

For a forced air system (such as a fan duct system), pressure loss is the loss of total pressure in a duct fitting caused by dynamic and frictional forces of the duct fitting measured over the entire path length. The equation is represented as Total Pressure Loss (ΔPt)=(Static Pressure (ΔPs)+Velocity Pressure (ΔPv)). It is a rule that only total pressure in duct fittings always drops in the direction of flow; static or velocity pressures alone do not follow this rule. In residential, commercial and industrial HVAC configurations the maximum design air velocity is determined according to space, energy, control and operational considerations. In general, as the design air velocity increases there is an exponential increase in the total pressure loss for a fitting located along the critical path. To reduce pressure drop caused by turbulence at higher design velocities, typical contemporary design practice has commonly resorted to oversizing duct components to inversely reduce dynamic loss. This solution may have several drawbacks. Oversizing the duct work can dramatically increase labor and material cost associated with the overall system. In most circumstances, oversizing the ductwork is a characteristic of a poorly designed or executed duct layout. Additionally, oversized duct elements may require significantly larger ceiling plenums and vertical shafts within the building envelope. The consequence is a need for superfluous headroom. This limits the net program efficiency within a building and drastically increases capital cost associated with larger structural, cladding and mechanical components. Given these circumstances, there is a need to improve contemporary HVAC fitting design, construction and operation.

It would be desirable to have a duct fitting that reduces the associated total pressure loss (ΔPt) in excess of that produced by a traditional duct fitting.

It would be desirable to have an efficient duct fitting configuration that reduces energy consumption (measured in kWh) of mechanically driven ventilation fans.

It would be desirable to have a duct fitting configuration having reduced associated total pressure loss, thereby diminishing the need to oversize equipment.

### SUMMARY

In exemplary embodiments, a low air flow resistance HVAC duct fitting is provided with a plurality of aerodynamic vortex generating treatments formed in or associated with a duct wall containing a differential aspect ratio. In exemplary embodiments, the treatment may be a dimple or other depression. In exemplary embodiments, a moldable or ductile material is provided that augments the accommodating duct profile and surface condition throughout the diverging duct fitting to mitigate inertial forces induced as a result of axial deformation along the fluid conveying corridor.

In exemplary embodiments, provided are one or more traditionally circular inlets and outlets for connection by collar, flange, weld or other means to adjacent ducts in the system. At the axial apex of divergence that forms the elbow or equivalent fitting, the transverse cross-section of the duct may substantially have an elliptically inclined cross-section profile with the ellipse being equal to the circular area of the proceeding inlet(s) or outlet(s). The physical geometry of the elbow is thus complementary to the resulting differential aspect-ratio achievable relative to the dimension of the supply conduit while maintaining a uniform cross-sectional area along the extent of the bent or diverging portion. The profile can subsequently host an agglomeration of surface treatments along the internal surface of the smallest radius of curvature.

### BRIEF DESCRIPTION OF THE DRAWINGS

The drawings disclose exemplary embodiments in which like reference characters designate the same or similar parts throughout the Figures of which:

FIGS. 1A-C are each an internal transverse sectional view of different prior art 90° duct elbows illustrating the associated flow disruption: FIG. 1A is a parallel square elbow; FIG. 1B is a rounded circular elbow; FIG. 1C is a rounded gored elbow.

FIG. 2 is an exterior perspective view of one exemplary 90° embodiment, illustrating the plurality of convex surface treatments about the small/inner radius of curvature.

FIG. 3 is a second exterior perspective view of the exemplary embodiment of FIG. 1, illustrating the smooth large/outer radius of curvature.

FIG. 4 is a planer view of the exemplary embodiment of FIG. 1, illustrating the plurality of convex surface treatments and varying aspect-ratio about the apex of divergence.

FIGS. 5A-C are planer view of three degrees of increasing axial deformation; FIG. 5A is at 0°; FIG. 5B is at 45°; and, FIG. 5C is at 90°.

FIGS. 6A-C are transverse sectional views of FIG. 5 depicting the varying geometric states of an exemplary elliptically inclined apex of deformation. FIG. 6A is at θ=0°; FIG. 6B is at θ=45°; and FIG. 6C is at θ=90°.

FIG. 7A is a sectional view of one exemplary embodiment of a smooth duct wall, comparing the aerodynamic benefit of localized surface texturing over that of a smooth surface.

FIG. 7B is a sectional view of one exemplary embodiment of a dimpled duct wall.

FIG. 8 is a detailed sectional portion of an exemplary duct wall illustrating the individual aerodynamic vortices induced as a result of the converging geometry between each embossed treatment.

FIGS. 9A-D are top schematic views of various exemplary embodiments of the geometry of the treatment.

FIG. 10 is an exterior elevation view of an exemplary 90° embodiment, illustrating the varying aspect-ratio and surface arrangement associated with L2 about the downstream plane of attachment.

FIG. 11 is an exterior elevation view of an exemplary 90° embodiment, illustrating the varying aspect-ratio and surface arrangement associated with L1 about the upstream plane of attachment.

FIG. 12 is an exterior perspective view of an exemplary embodiment of a conical reducing tee (“Y-junction”), illustrating the plurality of convex surface treatments relative to the up and multiple downstream planes of attachment.

FIG. 13 is a comparative graph demarcating the total pressure loss (ΔPt) associated with an exemplary 90° embodiment versus the pressure loss from conventional duct fitting samples.

FIG. 14 is a schematic view of the test device used to perform the tests which resulted in the graph of FIG. 13.

FIG. 15 is a side elevational view of an exemplary embodiment of an insert for a duct fitting, the insert being formable into a tube.

FIG. 16 is a side schematic view of an exemplary embodiment of an insert for a duct fitting.

FIG. 17 is a side elevational view of another exemplary embodiment of an insert for a duct fitting, the insert having telescoping sections.

FIG. 18 is a schematic diagram illustrating an exemplary HVAC system incorporating duct fitting apparatus of the present disclosure.

### DETAILED DESCRIPTION

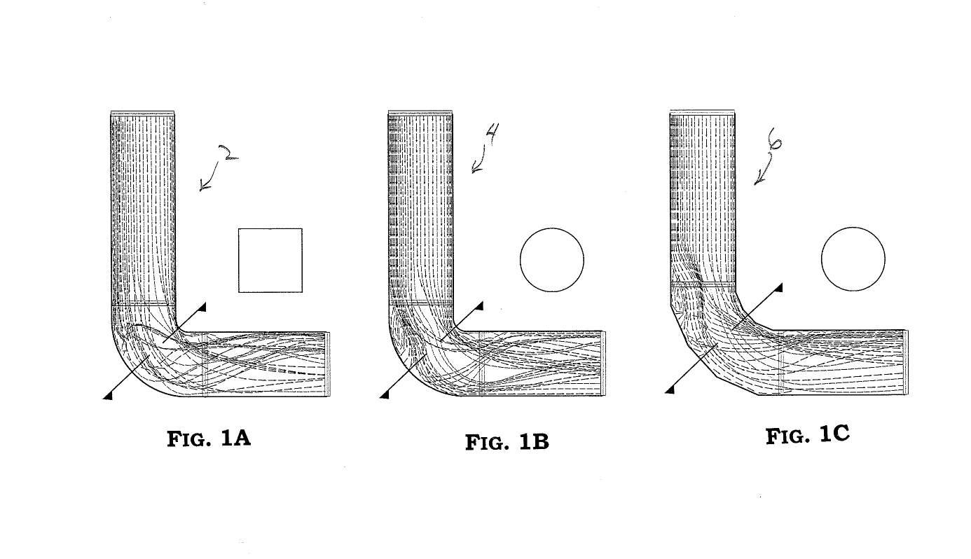

FIGS. 1A-C show several versions of conventional duct fitting elbow designs. FIG. 1A is a paneled square elbow 2. FIG. 1B is a rounded circular elbow 4. FIG. 1C is a rounded gored elbow 6.

A fully developed air flow with a corresponding Reynolds number in excess of about Re 4000 is assumed to be turbulent. While air is discussed herein, it is to be understood that any gas, liquid, semi-liquid, fluid, particulate material, or other flowable material, or mixtures of two or more of the foregoing, is intended to be included, From inlet to outlet, a continually flowing gas or fluid is conveyed through a bent or diverging fitting element of a ducting system. As air flow enters each 90° duct fitting, the faster moving laminas near the center axis get displaced outward due to inertial forces, creating zones of turbulence which, in some cases, invert the direction of flow, significantly increasing the systems accumulative head loss. It is to be understood that the term “duct” includes any type of conduit.

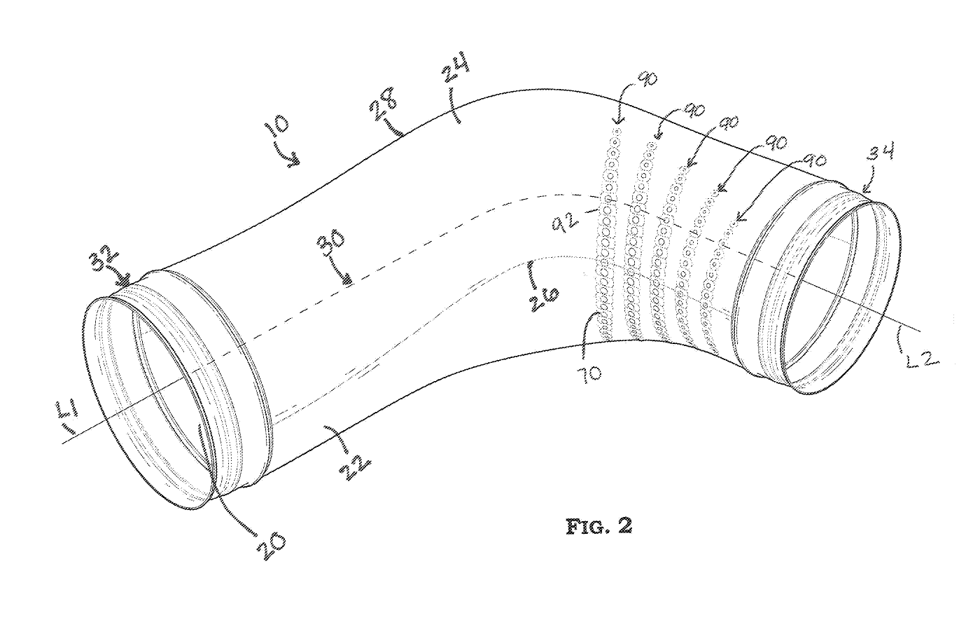

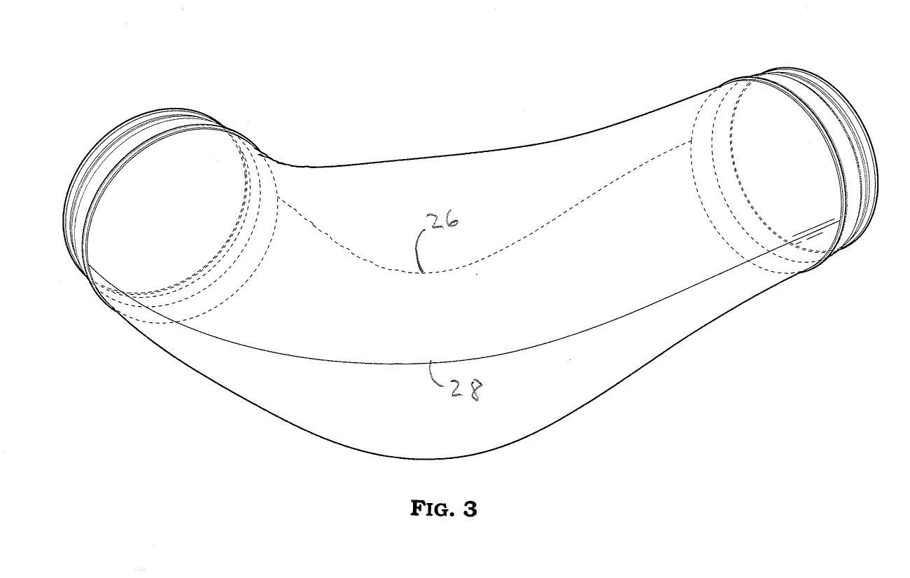

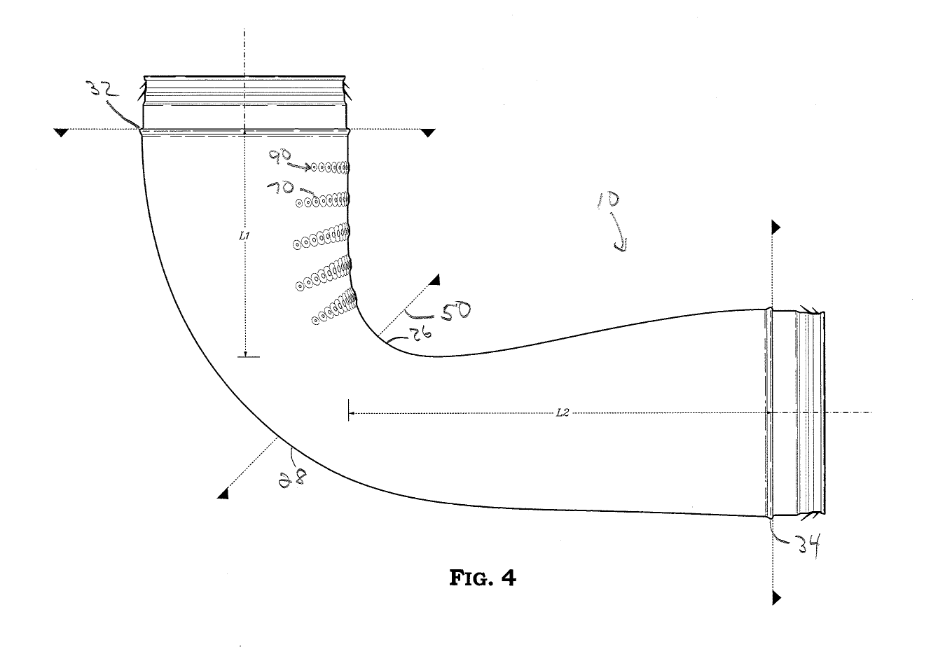

In order to mitigate this tendency, disclosed are various exemplary embodiments of an apparatus 10 comprising a duct fitting through which continuously flows a non-free surface fluid. Flow of a “non-free surface fluid” refers to a fluid which occupies substantially the entire cross-section of the duct when flowing past a given point; for example, water flowing through a fire hose fills substantially the entire cross-sectional diameter of the hose when flowing under pressure. The duct fitting 10 has an interior wall 20 and an exterior wall 22. The duct fitting (10) contains a bent or diverging portion 24, as shown in FIG. 2. At one end is an inlet opening 32 having an associated plane or point of attachment to a duct (not shown). At the other end of the duct fitting 10 is an outlet opening 34 having an associated plane or point of attachment. The duct fitting mates with existing upstream and downstream supply or exhaust ducts or conduits. The upstream and downstream points of attachment 32, 34 generally remain in the same axial positions as those of standard duct fittings being replaced by those described herein. That is, the intersection of an upstream center line L1 and a downstream center line L2 of each duct fitting 10 remains generally perpendicular to the planes of the respective attachment points, but generally assumes an asymmetrical relationship between the lengths of L1 and L2 (see, for example, FIGS. 4, 10 and 11). In exemplary embodiments, the duct material may be formed of a ferrous metal, non-ferrous metal, composite, plastic, thermoplastic, combinations of the foregoing or the like. In exemplary embodiments, the duct material may be formed from polyvinylchloride (PVC).

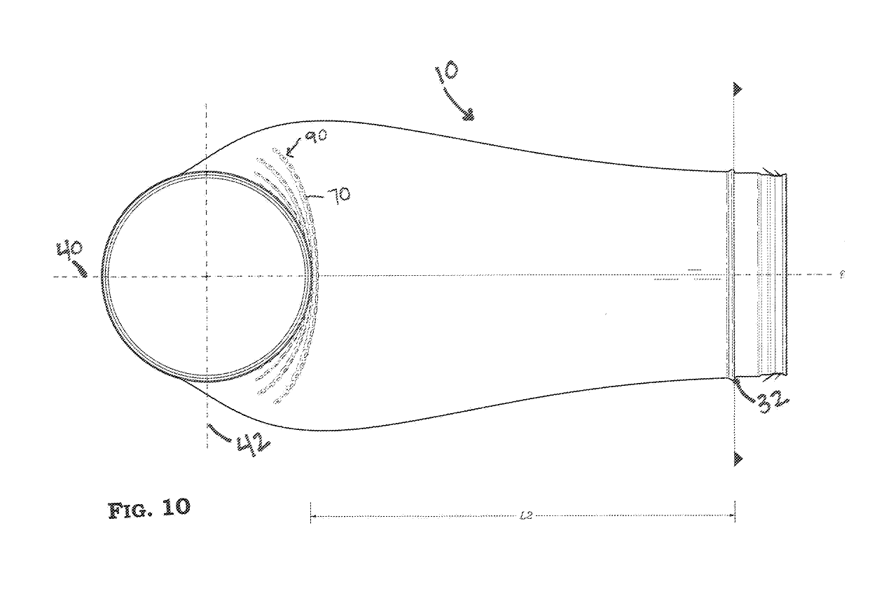

One function of the duct fitting 10 is to adjoin two or more ducts at a diverging angle of equal or less than 90 degrees. Diverging duct fittings i.e., elbows, angled tee/wyes, offsets, include both a small/inner (22), and large/outer (24) internal flow-engaging surface profile. These internal surface profiles comprise the primary means by which a duct fitting may divert an otherwise free flowing fluid stream. These profiles are derived as a function of the aspect ratio, or the cross-sectional relationship perpendicular to the direction of flow measured along the extent of a duct fitting. Conventional circular duct fittings typically maintain profile regularity (see FIG. 1). That is, the relationship between the minor “X” axis 40 and major “Y” axis 42 of the fitting maintains a circularly inclined 1:1 aspect ratio from inlet 32 to outlet 34 (see FIG. 10). This regularity inhibits the ability to tailor the cross-section according to the severity of the required angle of divergence. The angle of divergence is understood as the extent to which a fluid stream is altered from its original direction by a duct fitting. For example, a duct fitting with 45° bend has an angle of divergence of 45° because the fluid at the duct fitting outlet is diverted 45° from the direction off flow coming from the inlet.

In order to better condition turbulence as a result of fluid separation and inertial forces, exemplary embodiments of the disclosed apparatus provide a graduating differential (non-uniform) aspect ratio. The differential aspect ratio is the relationship between the minor X 32 and major Y 34 axes of an elliptically inclined cross-section. A uniform aspect ratio is that of a circle; i.e., the cross-sectional diameter in the X-axis direction equals the cross-sectional diameter in the perpendicular Y-axis direction. Accordingly, the aspect ratio X:Y equals 1:1, or, a “uniform” aspect ratio. As either the X or Y axis diameter increases with respect to the other the aspect ratio of X:Y changes. For example, if a circle is flattened into an ellipse, the X-axis diameter may increase to 2 and the Y-axis diameter decrease to 0.5, then the aspect ratio of X:Y is 2:0.5 (or, simplified, 4:1). When referring to an elliptically shaped cross-section, it is not meant to imply that this section is necessarily a mathematically precise ellipse. However, in exemplary embodiments, the apparatus aspect ratio changes along at least a portion of the length of the duct from a traditionally circular 1:1 upstream aspect ratio to an elliptical aspect ratio perpendicular to the direction of flow. The extent of the aspect ratio change can be optimized in conjunction with the apex of divergence 50. The apex of divergence 50 (see FIG. 4) demarcates an angularly related plane of maximum elliptically shaped area within the length of the duct fitting. In the 90° elbow illustrated in FIG. 4, plane 52 is at an approximately 45° angle to the plane of attachment 32. For other desirable fitting angles, the plane of maximum elliptical cross-section 52 may be approximately one-half (θ/2) of the total fitting diverging angle (θ) perpendicular to the direction of flow relative to the centerlines of lengths L1 and L2.

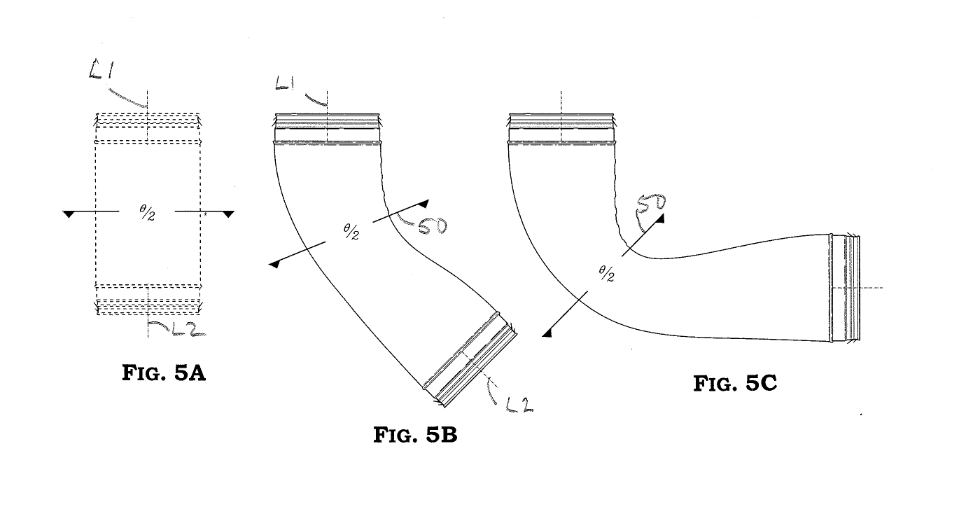

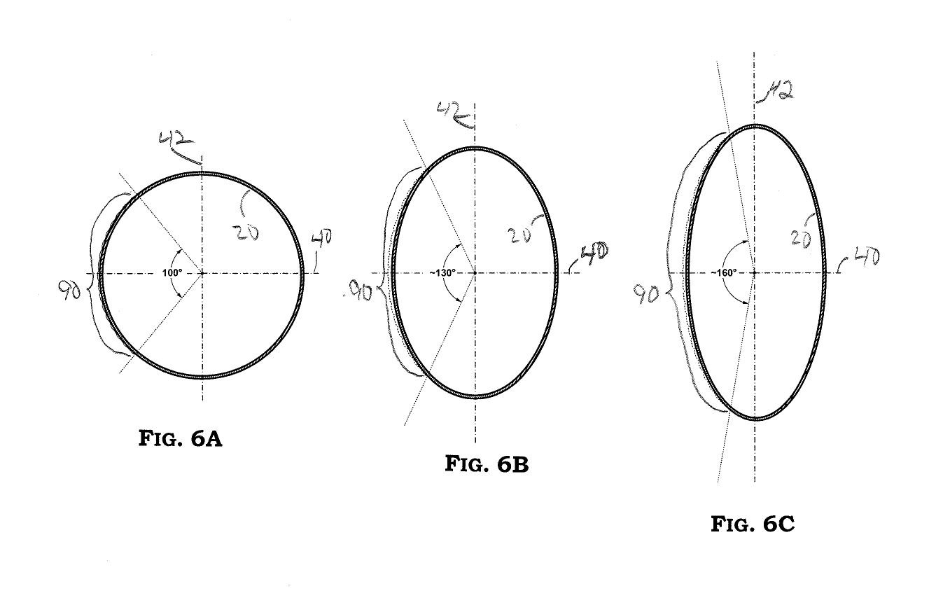

The amount of elliptical aspect ratio change of the duct profile is proportional to the fittings total diverging angle of the duct fitting. In exemplary embodiments, as illustrated in FIGS. 5A-C and 6A-C, an air duct with an inlet 32 and outlet 34 diameter, for example, but not as a limitation, in a range of about 3-24 inches is superimposed about three degrees of increasing axial deformation: 0° (FIGS. 5A, 6A), 45° (FIG. 5B, 6B) and 90° (FIG. 5C, 6C). The aforementioned range is a select sample size, intended to be representative of all values between >0° and ≦90° and describes a relationship between the minor X and major Y axes 40, 42 of the elliptically inclined cross-section. In exemplary embodiments, the aspect ratio is at least about 1:1 and less than about 2.4:1 for a 90° bend duct fitting 10. That is, to accurately describe the appropriate aspect ratio for any degree of axial deformation, a range can be established wherein the 0° embodiment demarcates the minimum value of at least 1:1, and 90° embodiment as the maximum value of about 2.4:1 as illustrated in FIG. 6. Given the large assortment of variable duct sizes, flow rates, operational constraints and unforeseeable design considerations, a degree of variability exists within the disclosed range. However, in exemplary embodiments, each aspect ratio is derived utilizing this graduating scale.

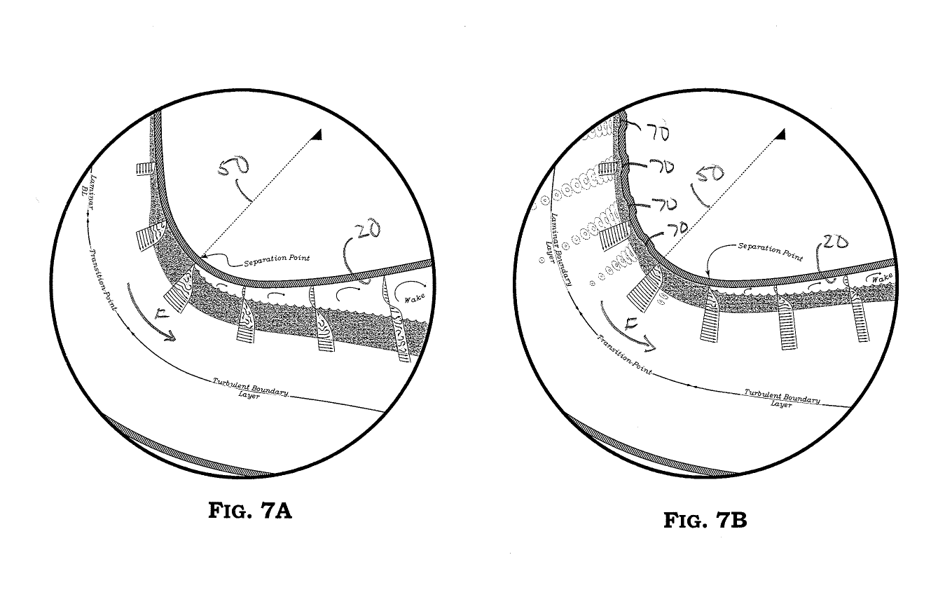

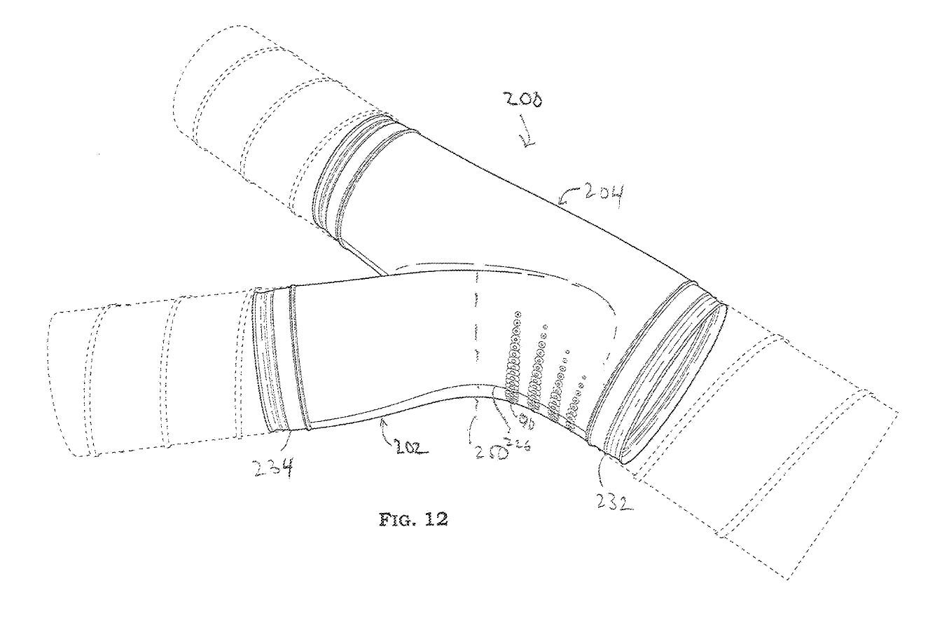

In exemplary embodiments, the area of the elliptically shaped cross-section can remain the same as the area of the inlet 32 and outlet 34 attachment points in order to negate turbulence associated with pressure changes along the extent of the fitting. In circumstances involving asymmetrical arrangements, such as tapered 60 or conical 62 fittings (as shown in FIG. 12), it may be necessary for the elliptically shaped cross-sectional area to be different than that of the proceeding inlet or outlet attachment points 32, 34, in which case the appropriate aspect ratio of the elliptically shaped cross-section along plane 52 remains a function of the degree of axial deformation. Moreover, the appropriate area of the elliptically shaped cross-section is a result of the averaged inlet and outlet area attachment points 32, 34. This ensures the appropriate mitigation of negative pressure gradients across the apex of divergence 50 reducing the distance between the small/inner 26 and large/outer 28 wall radii along the minor X 40 axis parallel to the primary direction of flow (shown as arrow F in FIG. 7B). For the purposes of clarification, “inner” wall 26 refers to the portion of the curve, whereas “interior” refers to the internal surface of the wall within the duct fitting 10.

To further increase the efficient conveyance of fluid beyond the apex of divergence 50, it can be advantageous to delay boundary layer separation following (i.e., downstream of) the point of maximum divergence 50 along the small/inner wall radii 26. Boundary layer separation occurs when a portion of the slow moving fluid closest to the interior duct wall reverses in flow direction beyond the separation line. As a result, the overall boundary layer suddenly thickens and is then forced away from the duct wall by the reversed flow at its bottom. To mitigate fluid separation, a plurality of surface treatments 70, such as, but not limited to, an array of depressions, are formed in the duct wall 20 along the internal flow engaging surface of the smaller/inner radius of curvature 26 (see FIG. 4). Individually, each treatment 70 functions as a small aerodynamic vortex generator creating tip vortices, which draw energized, rapidly-moving air from outside the slow-moving boundary layer into contact with the duct wall 20. This boundary layer of air becomes turbulent in its flow patterns over the surface treatments of the air engaging surfaces. Rather than flowing in smooth continuous layers over the air engaging surface, the treatments 70 cause the airflow to accumulate streamwise fluctuations and randomized flow (as illustrated by the flow line F in FIG. 7B). The newly generated turbulence in the boundary layer enables the air to better follow the contour of the air engaging duct wall around the curve, thereby reducing the pressure loss and improving efficiency.

In exemplary embodiments, the extent of the surface treatment texturing may be localized along the internal flow-engaging duct wall 20 surface of the smaller/inner radius of curvature 26 relative to the fluid separation line. The fluid separation line demarcates the local point of boundary layer separation and may be identified using such means as computational fluid dynamics software (CFD) or optical means, such as, but not limited to, flow-line analysis, laser source detection or the like. Boundary layer separation generally resides at or prior (upstream) to the apex of divergence 50 in fittings employing smooth surfaces. A feature of the exemplary embodiments of the apparatus is boundary layer separation delay beyond or after (downstream) of the apex of divergence 50 along the small/inner duct wall radii 26.

FIGS. 7A and 7B shows the aerodynamic aspects of the surface texturing of the treatments 70 along the small internal radius of curvature 26. FIG. 7B illustrates a comparative advantage over that of a smooth surface (FIG. 7A) by keeping the local flow attached to the duct wall 20 for as long as possible beyond the apex of divergence 50. When determining the optimal shape, dimension and density of the particular surface treatments 70 utilized, the overall pressure, diameter and boundary layer thickness characteristics of the desired or existing ducting system should be considered.

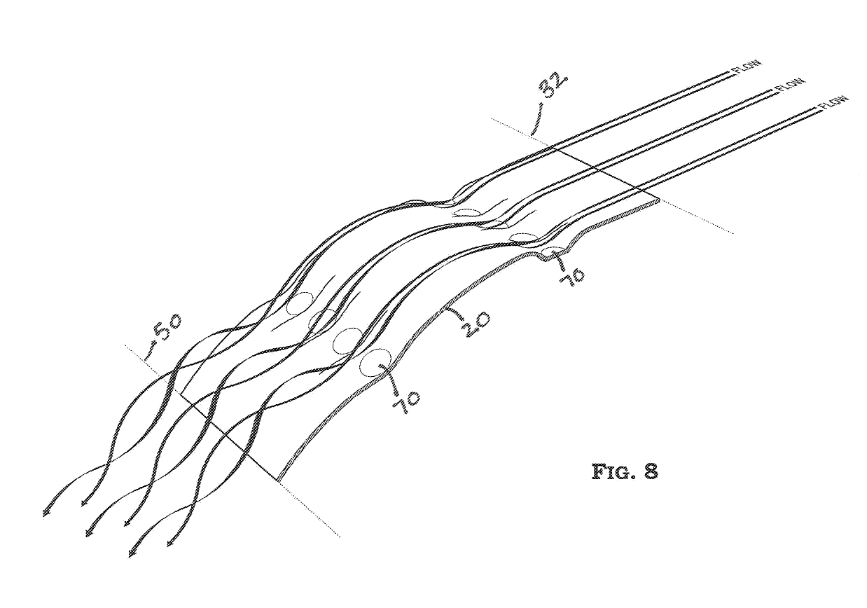

In exemplary embodiments, the surface treatment 70 comprises a plurality of multi-sided converging conical depressions or “dimples”. In exemplary embodiments, the individual treatments 70 may have diameters in a range of about 0.0625-0.5 inches. In exemplary embodiments, the individual treatments 70 may have depths in a range of 0.03125-0.1875 inches relative to the internal flow engaging surface of the duct. In exemplary embodiments, each dimple-type treatment 70 can form a concave airfoil drawing fluid flow closer to the duct wall 22. In exemplary embodiments, the individual treatments 70 provides an arrangement of small oblique surfaces about 80% as deep as the local boundary layer where the converging geometry is arranged in successive rows (see FIG. 8). In exemplary embodiments, the size, shape depth and arrangement of the treatments 70 may vary across the duct wall surface 22. In exemplary embodiments, the treatment 70 may be any of a variety of different shapes, including, but not limited to, hemispherical, oval, conical, hexagonal, tetrahedral, other multi-sided polygonal shapes, or the like. In exemplary embodiments, the treatments 70 can have an irregular shape. In exemplary embodiments, the treatments 70 can be slots or grooves formed in the duct wall 22.

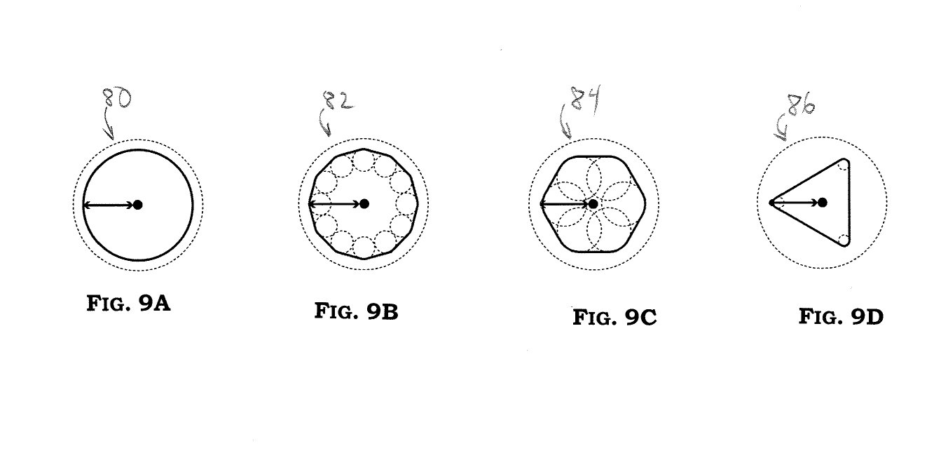

Several exemplary embodiments of symmetrical and non-symmetrical treatment shapes include those illustrated in FIGS. 9A-D. FIG. 9A is an exemplary embodiment of a streamwise circular or infinitely sided symmetrical depression 80. FIG. 9B is an exemplary embodiment of a streamwise dodecagon or twelve sided symmetrical depression 82. FIG. 9C is an exemplary embodiment of a streamwise hexagon or six sided symmetrical depression 84. FIG. 9D is an exemplary embodiment of a streamwise three-sided non-symmetrical depression 86.

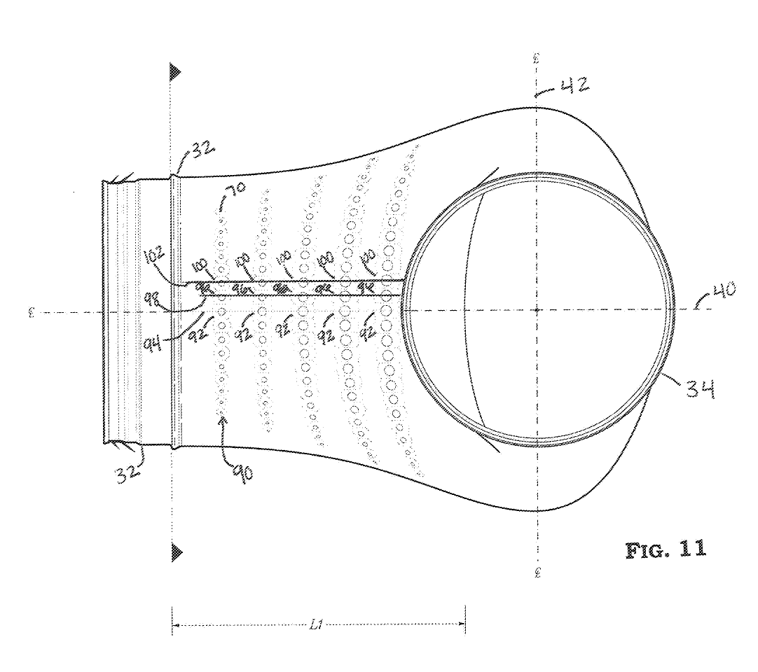

In exemplary embodiments, placement of the treatments 70 along the inner/small duct wall 22 should be optimized. The distance from the identified boundary layer separation point should not be too small, since the position of the separation point changes relative to duct profile and varying operating conditions. On the other hand, the distance from the separation point should not be too great, since the effect of the treatment 70 is reduced when the distance increases. In exemplary embodiments, such as is shown in FIG. 11, the treatments 70 can be as series of rows 90. In exemplary embodiments, each row 90 may have the same number of treatments 70. In alternative exemplary embodiments, the rows 90 may have different numbers of treatments 70. In exemplary embodiments, the rows 90 may have treatments 70 all the same diameter. In alternative exemplary embodiments, as illustrated in FIG. 11, the treatment 70 diameter may be larger near the middle of the row 90 and become progressively smaller toward the ends of the row 90.

In exemplary embodiments, illustrated in FIGS. 4 and 11, a plurality of rows 90 is provided, each row 90 being generally parallel to a line L3. The line L3 is a line perpendicular to the central axis 30 of the duct fitting 10 at the point where the row 90 is. Therefore, the rows 90 are generally perpendicular to the central axis 30. The rows 90 follow the curvature of the duct fitting cross-section as the aspect ratio changes; i.e., the rows 90 partially wrap around the duct fitting wall 20.

In exemplary embodiments, a first row 90 of treatments 70 can located anywhere between the apex of divergence 50 and the upstream inlet attachment plane 32. In exemplary embodiments, each row 90 of treatments 70 wraps around (i.e., follows the curvature of) a portion of the interior of the duct fitting wall 22. In exemplary embodiments, the row curvature may extend up to about 160° about the plane of maximum elliptical cross-section 50. In alternative exemplary embodiments, such row curvature may be up to about 180°. In exemplary embodiments, the row curvature may extend up to about 100° about the plane of inlet attachment 32 (see FIGS. 6A-C). In alternative exemplary embodiments, such row curvature may be up to about 180°. In one exemplary embodiment, the row curvature is 160° about the plane of maximum elliptical cross-section 50 and 100° about the plane of inlet attachment 32. Such an arrangement can proportionately dispose a varying quantity of treatments 70 relative to the line of separation along the duct profile, prior to the apex of divergence 50.

In exemplary embodiments, at least a portion of the treatments 70 are also aligned between rows 90 as follows. As shown in FIG. 11, the center first treatment 92 in each row 90 may be generally co-axial with the lines L1 and L2, thus forming an alignment, noted by alignment line 94. In each row 90 the second treatment 96 that is adjacent to this center first treatment 90 is aligned, thus forming an alignment line 98. In each row 90, the third treatment 100 that is adjacent to this second treatment 96 is aligned in an alignment row 102, and so on. Since the rows 90 may not all have the same number of treatments 70, toward the ends of the rows 90 there may not be a treatment in a given row or rows that can be aligned.

In exemplary embodiments, the distance between treatments 70 in a given row 90 can increase from the center to the edge. In exemplary embodiments, the diameter of each treatment 70 in a given row 90 can decrease from the center to the edge.

In exemplary embodiments, the arrangement of treatments 70 may form one or more patterns, including, but not limited to, tapered, uniform, offset, parallel, or other regular patterns. In exemplary embodiments, the arrangement of treatments 70 may have a random appearance. In exemplary embodiments, treatments 70 may comprise an array of uniform size, or may comprise an array of various sizes, including, but not limited to, a tightly spaced pattern of larger and smaller treatments; for example, larger dimpled depressions intermingled with smaller dimpled depressions. In exemplary embodiments, one design can incorporate combinations of two or more different forms of treatments 70 along a number of rows generally perpendicular to the direction of flow. In exemplary embodiments, the duct fitting aspect ratio and interior diameter will determine the optimum number of rows 90 and treatments 70 per row 90. Generally stated, in exemplary embodiments, the higher the aspect ratio (at a given point in the duct fitting curve) or the larger the duct fitting diameter, the greater the number of rows 90 of treatments 70. Similarly, the larger the duct fitting diameter, the greater the number of treatments 70 per row 90 that may be needed. In general, the appropriate configuration produces an advantageous reduction of fluid separation without causing a material pressure drop (ΔPt) in excess of that produced without the treatments. FIGS. 2, 4, 10, and 11 illustrate exemplary embodiments of an arrangement of the rows 90 of treatments 70 relative to lines L1 and L2. However, in practice these formed surfaces may demonstrate a degree of variability. Various configurations may be tested in order to obtain the optimal result.

The aerodynamic vortex generation phenomenon involves addressing boundary layer or sheet separation present within the duct fitting 10. This thin pressure sheet defines the perpendicular transition between more viscous and less viscous flows along the internal wall 22 of any duct experiencing axial deformation. The instability of flow is induced as faster moving fluid is drawn toward the smaller/inner radius of curvature 26 but is then displaced outward as it passes through the bent or diverging duct component. As a result, fluid flow separates from the inner radius forming large parting vortices which propagate further downstream fluctuations. Adverse pressure gradients induced between the surface interaction of the duct and transitory fluid may be limited through strategically formed treatments 70 along the duct fitting internal wall 22. The treatments 70 create a turbulent flow localized along the interior surface of the duct, propagating the agglomeration of small tip vortices which, when paired with a differential aspect ratio, maintain a marked reduction of downstream turbulence and a reduction of total pressure loss (ΔPt).

FIG. 12 shows an exemplary embodiment of a Y-junction duct fitting 200 having a branch 202 and a main section 204. The transition from the plane of maximum elliptically shaped area 250 to the circular end of the duct fitting at the outlet attachment 234 is different than that of the inlet attachment 232 (the fluid flow direction being from the inlet to the outlet, with a portion of the fluid passing into the duct fitting branch). If the inlet 232 and outlet 234 profiles are symmetrical about the midsection of divergence 250, as fluid flow exited the bent or diverging branch 202, faster moving laminas near the center axis would have a tendency to displace outward, causing slower moving laminas along the smaller/inner radius of curvature 226 to separate and form large downstream parting vortices. To counteract this tendency, following the apex of divergence 250 the small/inner duct wall 232 transitions through a non-symmetrical broadening perpendicular to the downstream plane of attachment 234. This small/inner duct wall expansion is gradual and relative to the downstream centerline L1 of the duct interconnecting the inside of the elliptically shaped portion 250 and the inside of the outlet attachment 234 resulting in improved transition of fluid flow beyond the apex of divergence 250 along the length of the branch 202. While the small/inner 232 duct wall of the outlet transition is asymmetrical in relation to the center line L1, the large/outer wall portion 234 remains substantially linear lengthwise along L2 that interconnects the outside of the elliptically shaped portion 250 and the outside of the outlet attachment 234. That is, the elliptically shaped duct wall on the large/outer wall radii 234 of the outlet side transitions into a circular cross-section of duct that terminates in the outlet attachment 234.

In exemplary embodiments, the treatments 70 can be protrusions extending from the wall surface. In exemplary embodiments, the protrusions can be bumps, ribs, tabs, fins, fingers, teeth, combinations of the foregoing, or the like. In exemplary embodiments, a generally smooth (i.e., not sharp-edged) protrusion may better resist clogging by dust or other particles over time. It is to be understood that discussion herein of depressions, dimples or other recesses formed in the duct wall as treatments 70 can include protrusions as well.

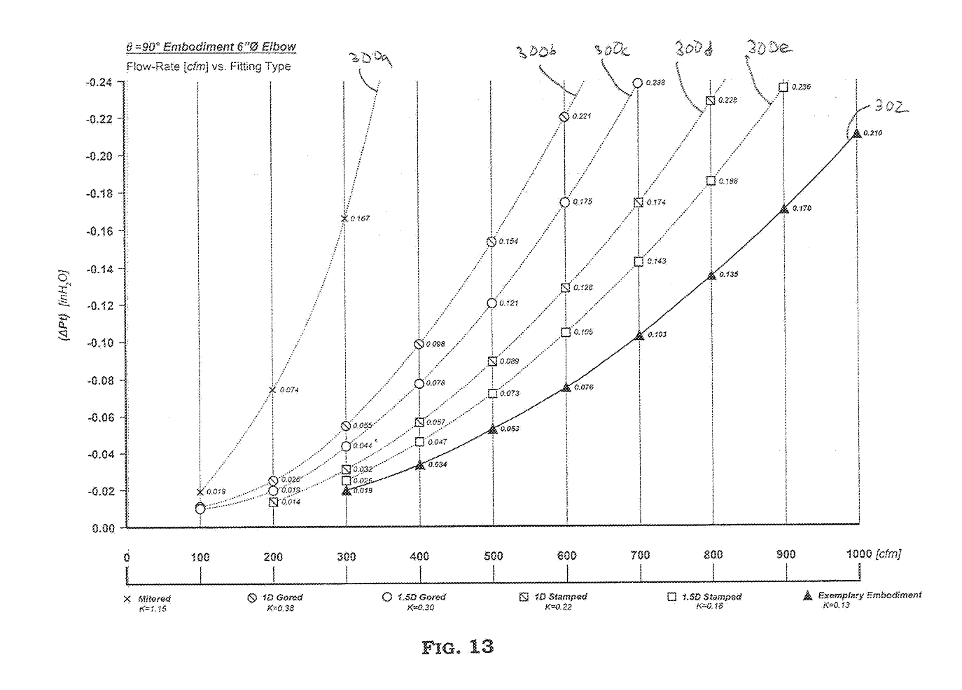

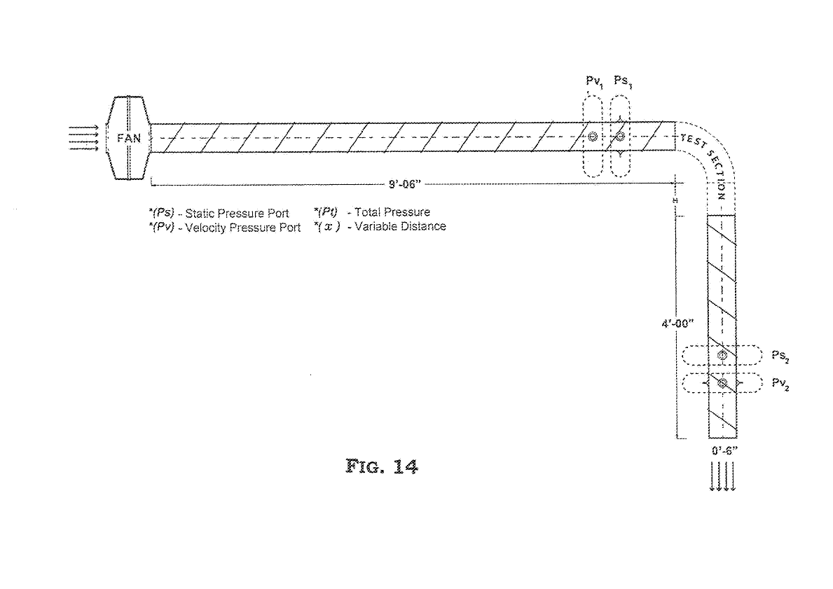

The graph shown in FIG. 13, shows results obtained from bench testing of one exemplary embodiment of a duct fitting apparatus 10 formed with a 90° bend. The comparative results illustrate the total pressure loss (ΔPₜ) associated with several different commercially available conventional duct fitting types versus that of one embodiment of the presently disclosed duct fitting apparatus 10. A collection of one minute total pressure (ΔPₜ) readings were detected by a differential manometer utilizing both an upstream and downstream averaging pitot tube. FIG. 14 illustrates the physical testing apparatus, equipment and measuring locations utilized to obtain the disclosed performance data. To minimize inaccuracies as a result of turbulence, both the static and velocity pressure ports (Ps₁) and (Pv₁) were positioned approximately 9.5 feet or 18 duct diameters downstream from the centrifugal fan face. The primary testing location occupied the adjoining space between the upstream 9.5 ft duct segment and a further downstream 4 ft duct segment. This 4 ft downstream segment accommodated an additional static and velocity pressure port (Ps₂) and (Pv₂). Utilizing a chosen fitting embodiment, both the up and downstream duct segments were joined in succession. Following the establishment of a steady-state volumetric flow rate, a differential static (Pₛ), velocity (Pᵥ) and total pressure (Pₜ) measurement was detectable across the fitting embodiment.

For comparison purposes, each fitting type received a designating irreversible loss coefficient. Each coefficient or “K” value, denotes the magnitude of local pressure loss (ΔPₜ) within a particular fitting type The equation for “K” can be represented as:

$$Δ {p}_{dy} = K {p}_{v} = \frac{K {ρ}_{o} {v}_{o}^{2}}{2 {g}_{c} {C}_{f}} = {K ( \frac{v}{4005} )}^{2} -> K = ( \frac{Δ {p}_{dy}}{{( \frac{v}{4005} )}^{2}} )$$

where:

K=irreversible loss coefficient or dynamic loss coefficient

ρₒ=air density lb/ft³ (kg/m³)

p_{dy}=dynamic loss

p_{y}=velocity pressure

pₜ=total pressure

vₒ=mean air velocity of air stream at reference cross section (fpm)

g_{c}=dimensional constant, 32.2 lbₘ·ft/lb_{f}·s², for SI units, g_{c}=1

C_{f}=conversion factor, for SI units C_{f}=1

Generally, a lower K value is more desirable as it is indicative of lower total pressure loss for a given duct fitting. An extensive collection of “K” values for common use fittings are tested and published each year through ASHREA (American Society of Heating, Refrigerating and Air-Conditioning Engineers) and other trade associations. In order to establish a collective baseline, all comparative fittings were retested. Curves (300a-e) represent the test data for each comparative fitting type. All result data verified a negligible (±4%) deviation from values published throughout the public domain.

The graph shown in FIG. 13 shows the extended pressure retention rates for a collection of 6″Ø fittings, measured in inches of water (in H₂O) as a function of increasing air flow volume measured in cubic feet per minute (CFM). The 6″Ø testing configuration was chosen both for its commercial commonality and characteristically high levels of resistance above 500 CFM. The exemplary embodiment tested had a differential aspect ratio of about 2.3:1. Prior to the apex of divergence, five perpendicular rows 90 of circular conical depressions 70, ranging from about 0.375 inches-0.125 inches in diameter and 0.04-0.08 inches in depth, occupied the internal small/inner radius of curvature. Curve (44), with triangular point markers, shows the total pressure loss (ΔPt) measured for this embodiment with an irreversible loss coefficient of only K=0.13.

For purposes of evaluation, a selection of conventional commercially available 90° duct fittings was utilized as comparative examples of K values.

TABLE 1
6″Ø, 90° Elbow @ 500 CFM Test Results

| | | | | | Effi- | |
|---|---|---|---|---|---|---|
| | | | | (ΔPt) | ciency | |
| FITTING TYPE | (Pt₁) | Curve | (Pt₂) | inH₂O | % | K |
| 1D Gored Elbow | 0.32 | 300b | 0.16 | −0.16 | 70.00% | 0.38 |
| 1.5D Gored Elbow | 0.30 | 300c | 0.18 | −0.12 | 58.00% | 0.30 |
| 1D Stamped Elbow | 0.28 | 300d | 0.19 | −0.09 | 37.00% | 0.22 |
| 1.5D Stamped Elbow | 0.26 | 300e | 0.19 | −0.07 | 30.00% | 0.18 |
| Exemplary | 0.26 | 310 | 0.21 | −0.05 | — | 0.13 |
| Embodiment | | | | | | |

Also included in graph of FIG. 13 are the individual results for each comparative fitting type. Curve (300a), with X-shaped markers, shows the total pressure loss (ΔPt) measured for a first comparative fitting having a two-piece mitered air engaging profile, K=1.15. Note: curve (300a) never exceeds the 500 CFM datum and is therefore intentionally omitted from Table 1. Curve (300b), with hatched circle shaped markers, shows the total pressure loss (ΔPₜ) measured for a second comparative fitting having a four-piece 1D (1 Diameter) radius gored air engaging profile, showing K=0.38. Curve (300c), with open circle shaped markers, shows the total pressure loss (ΔPₜ) measured for a third comparative fitting having a five-piece 1.5D (1.5 Diameter) radius gored air engaging profile, showing K=0.30. Curve (300d), with hatched square shaped markers, shows the total pressure loss (ΔPₜ) measured for a fourth comparative fitting having a 1D (1 Diameter) radius stamped/pressed air engaging profile, showing K=0.22. Curve (300e), with open square shaped markers, shows the total pressure loss (ΔPₜ) measured for a fifth comparative fitting having a 1.5D (1.5 Diameter) radius stamped/pressed air engaging profile, showing K=0.18.

Table 1 above shows that the tested exemplary embodiment duct fitting apparatus 10 had a 30%-70% improvement in the total pressure retention (ΔPₜ) at the 500 CFM/2500 fpm point shown in FIG. 13. The test results shown by curve 302 show that the tested exemplary embodiment created a pressure loss lower than any of the other fitting types tested across the large majority of the range of the graph, particularly beyond 500 CFM. In addition, it is noteworthy that curve 302 is the least upward trending. With an irreversible loss coefficient of only K=0.13, the tested embodiment of the presently described duct fitting apparatus 10 demonstrated significant pressure retention across a wide range of commercial flow rates. The benefits obtained are also a function of the system size (CFM and number of fittings), average system air velocity, reduction in pressure loss coefficient (K) and regional power prices. The analysis in FIG. 13 suggests substantial savings for large systems employing medium air velocities (1500-3000 fpm), and shows that the exemplary embodiments of the duct fitting apparatus 10 are particularly essential for large and/or high velocity systems (2000-4000 fpm). These improvements can be attributed, in part, to lower inertial forces between the small/inner (22) and large/outer (24) wall radii, in combination with a 3-5% improvement of streamwise boundary layer adhesion beyond the apex of divergence (26).

Exemplary embodiments of the presently disclosed apparatus can provide an overall reduction of the necessary fan energy (measured in kWh) to achieve the desired ventilation requirement (38). When utilized as a direct substitute in new or existing HVAC construction, exemplary embodiments of the presently described apparatus can significant limit the total pressure loss (Pt loss) of the entire ducting system. The accumulative life-cycle cost savings may be calculated by factoring in the total efficiency of the fan, including blades, mechanical motor and design velocity. In general, exemplary embodiments of the presently disclosed apparatus may reduce the size (tonnage) and therefore the cost premium associated with lower brake horse power (bhp) fan configurations. Improved pressure retention using exemplary embodiments of the presently disclosed apparatus can significantly reduce the operating costs associated with industrial, commercial or residential ventilation systems.

Duct products utilizing the apparatus disclosed herein may be outfitted as an industry standard, such as, but not limited to, the American Society for Testing and Materials (ASTM®), Sheet Metal and Air Conditioners' National Association (SMACNA®) and Underwriters Laboratories (UL®) compliant, and the like, as direct replacement fittings for round duct HVAC applications or applicable alternatives.

Installation of the presently disclosed apparatus can be performed in incremental stages within existing HVAC retrofit systems, or specified during the schematic design phase to maximize overall system efficiency in new construction. The use of a surface texture, such as an array of treatments as described herein, provides structural advantages to the duct fitting. Although retaining double curvature—or duct walls which contain two radii of curvatures in two planes—the average duct wall thickness remains very thin relative to the inlet 32 and outlet 34 diameters. To counteract a disposition to bend, buckle or flex during installation, the combined effect of the treatment-forming process (as described herein in exemplary embodiments) can artificially thicken the effective wall. By repetitively protruding into and/or extending out of the major plane of the air-engaging surface 26. An embossing process for forming the treatments 70 can increase the rigidity of the duct wall and enhance the resistance to flexing moments. The treatment-forming process (30) can impart a mirror-like finish on the internal duct wall as well as a unique marketable aesthetic on the external wall of the duct (36).

In exemplary embodiments, a duct fitting 10, such as, but not limited to, an elbow, tapered reducer, angled tee/wye lateral or the like, is provided in which an accommodating space is formed inside the duct to convey a fluid or gas. At the discretion of the manufacturer, any number of processes could be utilized to fabricate the duct component including but not limited to, die casting, stamping, hydroforming, tube forming, thermoforming, injection molding, 3D printing, combinations of the foregoing, and the like. The duct fitting 10 may be formed from any moldable or ductile material having suitable performance characteristics. In exemplary embodiments, the duct fitting 10 may be formed from extra deep drawing steel (EDDS) ASTM-A653, 26-20 gauge galvanized with G60 or better corrosion resistant coating.

One exemplary method of forming a duct fitting 10 may comprise utilizing a one or two part mold corresponding to the desired size, shape, application, and manufacturing process desired. A sheet metal blank is drawn into or over a forming die by the mechanical action of a press. Each forming die may account for final material shrinkage, trimming and include all critical geometric attributes of the aforementioned duct profile. Through pressure transformation, the material blank yields one-half of the corresponding duct fitting 10. Once removed from the press, the hemispherical blank is subjected to a secondary process which applies or forms the appropriate surface texture according to the desired design specifications. This secondary process of dimple creation may be accomplished independently or dependently from the formation of the duct fitting profile. Other possible methods of application include, but are not limited to, metal embossing, press forming, stamping, laser/water/plasma etching, CNC milling/lathing, incremental CNC hammer/vibration forming or other processes for treating a surface known to those skilled in the art. In the event a hydroforming process is used (such as, but not limited to, sheet, tube, bladder, bellows or otherwise), it is suitable for the texturing process to coincide dependently with the formation of hemispherical profile; i.e., both the hydroforming and texturing processes may take place jointly within the same forming die. Following forming, each hemisphere is cleaned to remove superfluous material or debris and is prepared for pairing to its symmetrical counterpart. In exemplary embodiments, a method of attachment utilizes a MID 181 Class 0/Class 1 compliant metal adhesive to maximize strength and leak prevention. Other possible methods of attachment include, but are not limited to, butt weld seam, stitch weld seam, standing seam, lock seam, or the like. Any supplementary components essential to the principal functionality including, but not limited to, additional coatings, insulation, gaskets, mounting hardware, or the like may be added at the manufacturer's or the end-user's discretion.

The duct fitting apparatus 10 as described herein in various exemplary embodiments utilizes unidirectional airflow over the surface treatments 70 particular to the physical properties of the conveyed fluid. The physical and geometric characteristics of the treatments 70 can be optimized for the desired application. In exemplary embodiments, the surface treatments 70 may be formed as part of the interior wall 22.

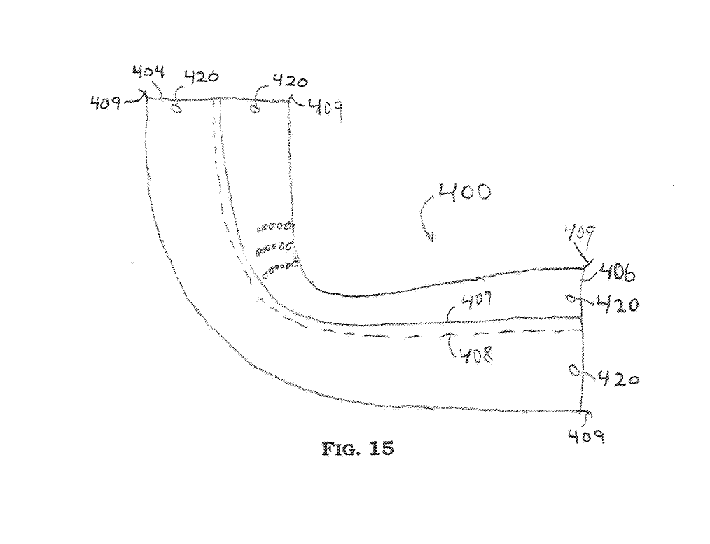

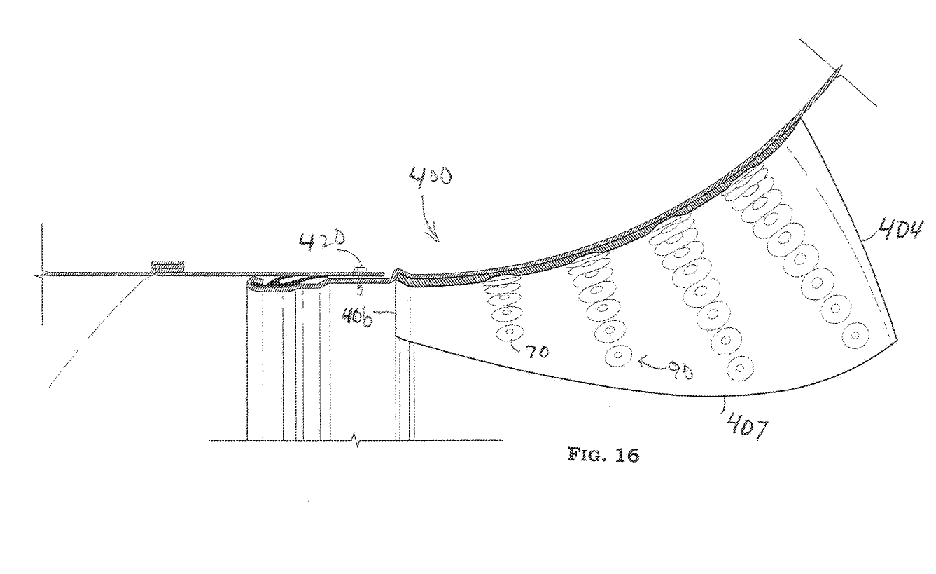

In exemplary embodiments, an insert 400 (shown in FIGS. 15-16), such as, but not limited to, a tube, sleeve, sheet, set of connected strips or other form is provided as a tube or which can be rolled into a tube or tube-like structure when rolled (i.e., having less than a 360 degree cross-section). The insert 400 can have one (inner) face 402 formed with treatments as described herein. In exemplary embodiments, the insert 400 may be permanently affixed to the interior wall of a conventional duct fitting. In exemplary embodiments, the insert 400 may be removable or interchangeable. In exemplary embodiments, the insert 400 is applied to the interior surface of the bent or diverging portion. In exemplary embodiments, the insert 400 may be made of a rigid bendable or rollable material or may be made of a flexible material. In exemplary embodiments, the insert 400 may be made of metal, plastic or the like. In exemplary embodiments, the insert 400 can be designed to prefit standard duct fitting configurations. In exemplary embodiments, the ends 404, 406 of the insert 400 can be cut to length. The inset has side edges 407, 408 that can meet or overlap when rolled. In exemplary embodiments, either or both ends 404, 406 may have a flanged edge 409 or a lip to reduce the likelihood of air or fluid passing between the insert 400 and the interior wall 20.

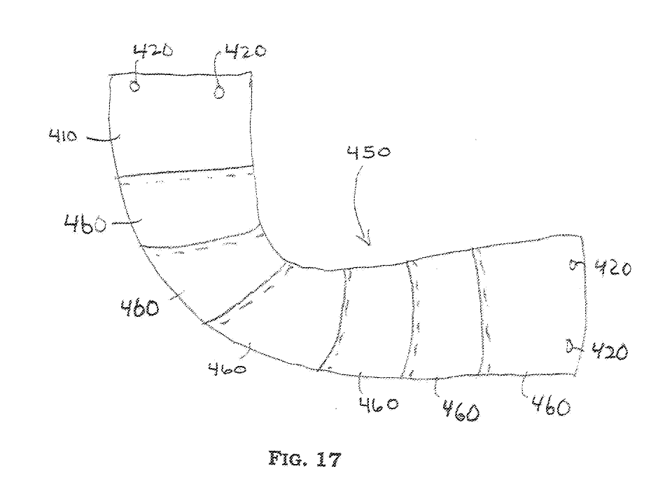

In exemplary embodiments, an insert 450 may be a set of telescoping tubes or tube-like sections 460 (see FIG. 17) that permit the insert to form a bend generally approximating the bend of the duct fitting.

In exemplary embodiments, a duct fitting kit is provided comprising a duct fitting and an insert 400 as described herein in exemplary embodiments.

In exemplary embodiments, a duct fitting kit is provided comprising a duct fitting, an insert 400 and a fixation means 420 for attaching the insert to the duct fitting. The fixation means 420 may comprise an adhesive, screw, nut and bolt, hook and loop fastener system (with each piece having one face that has an adhesive backing), snap, tab and slot, tongue and groove, combinations of the foregoing, or the like. Alternatively, the insert 400 may be force fitted or friction fitted in the duct fitting.

In exemplary embodiments, a kit may further include a registration device that enables a user to properly align the insert in the duct fitting.

In an alternative exemplary embodiment, a duct fitting is provided having a generally circular cross-sectional shape the entire length of the duct fitting; i.e., an aspect ratio of generally 1:1. Associated with the interior wall proximate to the inner curve of the wall and between the upstream inlet end and generally the midpoint of the arc of curvature are treatments as described herein.

While all viscous fluids exert shear stresses upon the walls of conduits which convey their medium, exemplary embodiments of the apparatus disclosed herein may be applicable to alternative industrial and commercial uses, such as, but not limited to, natural gas and oil transmission, water transmission, automobile intake and exhaust systems, industrial exhaust systems, aeronautical ventilation devices, vacuum/particle collection, medical gas delivery systems, and other ducting or conduit systems for conveying gas, liquid, semi-liquid, fluid, flowable particulate matter or mixtures of at least two of the foregoing.

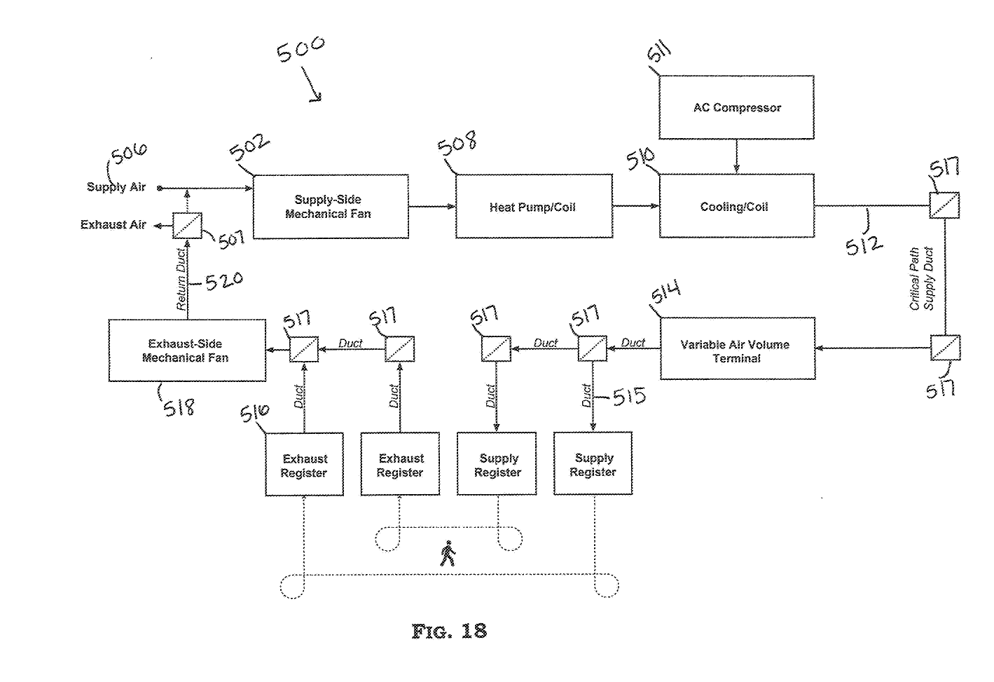

FIG. 18 is a schematic diagram of an exemplary embodiment of an HVAC system 500 and airflow incorporating duct fitting apparatus as disclosed herein. First, a supply-side centrifugal, vane or propeller fan 502 is mechanically driven by an electrical motor 504. Fresh supply-side air 506 enters the system 500 and is pressurized prior to passing through a combination of heat and/or cooling coils 508, 510. An air conditioning compressor 511 can be associated with the cooling coil 510. Once the supply air has been conditioned it enters the primary supply/trunk ductwork 512. These supply ducts 512 typically host the largest diameters, velocities and duct length of the critical path. For any fan duct system there exists a critical path, or design path of airflow, whose total flow resistance is maximum compared with other air flow paths. In the illustrated example, the critical path is the longest continual progression of ductwork prior to the variable air volume (VAV) terminal. Exemplary embodiments of duct fitting apparatus 10 as described herein are positioned within the supply passages to provide the optimal individual measure of total pressure retention. Following transmission beyond a VAV terminal 514, a series of auxiliary ducts 515 convey conditioned air to registers 516 the individual occupied spaces of the building. These auxiliary ducts 515, while smaller are significantly more numerous, complex and integral to the operation of the HVAC system as a whole. Exemplary embodiments duct fitting apparatus 10 as described herein at bend or junction points 517 positioned within the auxiliary passages provide the optimal accumulative measure of total pressure retention. At last one exhaust-side fan 518 draws return or exhaust-side air to a return duct 520. The return duct 520 exhausts air.

In another exemplary embodiment, an HVAC system is provided comprising a source of supply fluid (such as, but not limited to, air), at least one mechanism for drawing fluid through the system, ducting or conduit through which air is conveyed to a desired location, and at least one duct fitting apparatus as described herein adapted to connect to the ducting or conduit.

While the methods, equipment and systems have been described in connection with specific embodiments, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect.

This holds for any possible non-express basis for interpretation, including: matters of logic with respect to arrangement of steps or operational flow; plain meaning derived from grammatical organization or punctuation; the number or type of embodiments described in the specification.

As used in the specification and the appended claims, the singular forms “a,” “an” and “the” include plural referents unless the context clearly dictates otherwise.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods, equipment and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods, equipment and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

Any patents, applications and publications referred to herein are incorporated by reference in their entirety.

What is claimed is:

1. A duct fitting, comprising:
(a) an exterior wall;
(b) an interior wall;
(c) an upstream portion having a cross-sectional shape with an aspect ratio of about 1:1;
(d) a downstream portion having a cross-sectional shape with an aspect ratio of about 1:1;
(e) a middle portion having cross-sectional shape with an aspect ratio of up to about 2.4:1; and,
(f) a plurality of surface treatments comprising a plurality of depressions or protrusions associated with a portion of the interior wall.

2. The duct fitting of claim 1, wherein the duct fitting has an aspect ratio that changes along at least a portion of the length of the duct from a generally circular 1:1 upstream aspect ratio to an elliptical aspect ratio perpendicular to the direction of flow.

3. The duct fitting of claim 1, wherein the aspect ratio between the upstream portion and the middle portion changes in a range of between 1:1 and 2.4:1.

4. The duct fitting of claim 1, wherein the surface treatments are adapted to generate aerodynamic vortices in fluid passing therethrough.

5. The duct fitting of claim 1, wherein the duct fitting forms a bend having an inner curve and an outer curve, the treatments being positioned generally upstream of the inner curve and adapted to generate aerodynamic vortices proximate to the inner curve wall and downstream from a point of maximum divergence of a plane of maximum elliptically shaped area.

6. The duct fitting of claim 1, wherein the treatments are arranged in rows generally perpendicular to the central axis of the duct fitting.

7. The duct fitting of claim 6, wherein the diameter of the individual treatments in at least one of the rows tapers from generally the center of the row toward each end of the row.

8. The duct fitting of claim 6, wherein the rows occupy up to about 180° degrees about the plane of maximum elliptical cross-section (26) and up to about 180° degrees about the plane of inlet attachment (18).

9. The duct fitting of claim 6, wherein the rows occupy up to about 160° degrees about the plane of maximum elliptical cross-section (26) and no more than about 100° degrees about the plane of inlet attachment (18).

10. The duct fitting of claim 6, wherein the each row has a different degrees of curvature with respect to a central axis of the duct fitting.

11. The duct fitting of claim 1, wherein the number of rows and treatments per row are proportional to the duct fitting aspect ratio and the duct fitting internal diameter.

12. Wherein the treatments form one or more arrangements selected from the group consisting of tapered, uniform, offset, parallel and random.

13. The duct fitting of claim 1, wherein the small/inner duct wall of the outlet transition is asymmetrical in relation to the center line and the large/outer wall portion remains substantially linear lengthwise along a line L2 that interconnects the outside of the elliptically shaped portion (26) and the outside of the outlet attachment (20).

14. The duct fitting of claim 1, wherein the surface treatments have a multi-sided polyhedral shape.

15. The duct fitting of claim 1, wherein the surface treatments have a shape selected from the group consisting of hemispherical, oval, conical, hexagonal, and tetrahedral.

16. The duct fitting of claim 1, wherein the surface treatments are depressions having an average depth in a range of 0.03125-0.1875 inches relative to the internal flow engaging surface of the duct.

17. The duct fitting of claim 1, wherein the surface treatments have an average diameter in a range of about 0.0625-0.5 inches.

18. The duct fitting of claim 1, wherein the duct fitting has a total pressure drop fluid passing therethrough, measured as the irreversible loss coefficient (K), of about 0.13.

19. The duct fitting of claim 1, wherein the duct fitting comprises a material selected from the group consisting of ferrous metals, non-ferrous metals, composites, thermoplastics and combinations of the foregoing.

20. A duct fitting having a boundary layer separation downstream of the point of maximum divergence (26) along the small/inner wall radii (22).

21. The duct fitting of claim 1, wherein the treatments comprises an array of dimpled depressions formed in the duct relative to the plane of maximum elliptically shaped area (26), about the inlet attachment point (18), along the internal flow engaging surface of the smaller/inner radius of curvature (22).

22. A duct fitting, comprising:
(a) an exterior wall;
(b) an interior wall;
(c) an upstream portion having a generally circular cross-sectional shape;
(d) a downstream portion having a generally circular cross-sectional shape;
(e) a middle portion between the upstream portion and the downstream portion and having an elliptical cross-sectional shape, the change between the generally circular cross-sectional shape and the elliptical cross-sectional shape defining an aspect ratio, the aspect ratio being in a range of between 1:1 and 2.4:1; and,
(f) a plurality of surface treatments comprising a plurality of depressions associated with a portion of the interior wall, the surface treatments being arranged in a plurality of rows generally perpendicular to a central axis defined by the duct fitting, the surface treatments being positioned generally upstream of the inner curve and adapted to generate aerodynamic vortices in fluid passing therethrough proximate to the inner curve wall and downstream from a point of maximum divergence of a plane of maximum elliptically shaped area,
wherein the duct fitting has a total pressure drop fluid passing therethrough, measured as the irreversible loss coefficient (K), of about 0.13

23. A duct fitting, comprising:
(a) a main section;
(b) a branch section associated with the main section, the branch section having an exterior wall, an interior wall, an upstream portion having a cross-sectional shape with an aspect ratio of about 1:1, a downstream portion having a cross-sectional shape with an aspect ratio of about 1:1, and a middle portion having cross-sectional shape with an aspect ratio of up to about 2.4:1; and,
(c) a plurality of surface treatments comprising a plurality of depressions or protrusions associated with a portion of an interior wall of the branch section.

24. An insert for a duct fitting having an exterior wall; an interior wall; an upstream portion having a generally circular cross-sectional shape; a downstream portion having a generally circular cross-sectional shape; a middle portion having an elliptical cross-sectional shape; and, associated with a portion of the interior wall, the insert comprising: a sheet of material capable of being formed into a tube-like structure and having a first face having a plurality of treatments associated therewith comprising a plurality of depressions or protrusions arranged in a plurality of rows generally perpendicular to a central axis and adapted to generate aerodynamic vortices in fluid passing therethrough.

25. A duct fitting kit comprising a duct fitting as provided in claim 1 and an insert as provided in claim 21.

26. The kit of claim 22, further comprising a means for fixing the insert to the interior wall of the duct fitting.

27. The kit of claim 22, wherein the fixation means comprises either an adhesive, screw, nut and bolt, hook and loop fastener system, snap, tab and slot, or a tongue and groove.

28. The kit of claim 22, wherein the insert comprises a set of telescoping tube or tube-like sections that permit the insert to form a bend generally approximating the bend of the duct fitting.

29. A duct fitting having an exterior wall and an interior wall, an upstream end and a downstream end, the duct fitting comprising: means for generating aerodynamic vortices associated with the interior wall, wherein the duct fitting has an aspect ratio that changes along at least a portion of the length of the duct from a traditionally circular 1:1 upstream aspect ratio to an elliptical aspect ratio perpendicular to the direction of flow.

30. A duct fitting apparatus, comprising: a duct fitting having an irreversible loss coefficient (K value) of 0.13.

31. A duct system, comprising:
(a) a source of supply fluid;
(b) at least one mechanism for drawing the fluid through the duct system;
(c) at least one duct or conduit to convey air or other fluid; and,
(d) at least one duct fitting according to claim 1 adapted to connect to the duct or conduit.

32. A method of reducing total fluid pressure loss in a duct fitting, comprising: forming a plurality of treatments in the interior wall of a duct fitting, the treatments comprising a plurality of depressions, the depressions arranged in a plurality of rows generally perpendicular to a central axis of the duct fitting, the plurality of rows being located generally upstream of an inner curve defined in the duct fitting and adapted to generate aerodynamic vortices in fluid passing therethrough proximate to the inner curve wall and downstream from a point of maximum divergence of a plane of maximum elliptically shaped area.
